(19) United States
(12) Patent Application Publication
(10) Pub. No.: US 2003/0038928 A1
(43) Pub. Date: Feb. 27, 2003

(54) Remote image projector for hand held and wearable applications

(76) Inventor: Ray M. Alden, Raleigh, NC (US)

Correspondence Address: Ray M. Alden, 808 Lake Brandon Trail, Raleigh, NC, 27610, US

(21) Appl. No.: 10/016,006

(22) Filed: Dec. 1, 2001

Related U.S. Application Data
(63) Continuation-in-part of application No. 09/939,975, filed on Aug. 27, 2001.

(51) Int. Cl. G03B 21/00

(52) U.S. Cl. 353/122

(57) ABSTRACT

The invention described herein represents a significant improvement for the presentation of visual information when using handheld or wearable devices. In one embodiment, a handheld device such as a cell phone is modified to include a means for projecting an image onto a remote surface such as a remote surface (wall). Also integrated are a means to sense when the cell phone moves relative to the image on the remote surface (wall) and to offset said relative movement through a means for stabilizing the image. This invention thus enables the user of the cell phone to produce and interact with a large visual media display while the size of the cell phone is not significantly increased. Many handheld devices will be improved by incorporating the means to project a large stable image disclosed herein.

### BACKGROUND FIELD OF THE INVENTION

Handheld and wearable electronic devices have recently become very prevalent. Such devices provide user access to information in the least cumbersome, most portable manner. The main advantage of handheld and wearable devices is their portability, a user can bring it anywhere and use it anytime. Increasingly the functionalities of devices such as phones, personal computers, PDAs, pagers, video games, audio players, video players, and even print media tablets are converging in wearable and handheld electronics. Many observers believe that all of these devices will merge into one wearable or handheld device. Whereas the “wired” individual of today generally has several handheld devices in tow, soon the devices may all be replaced by one wearable or handheld did it all gadget. There still remains one aspect of a wearable and handheld devices which constrains their functionality, namely display screen size. Small image display devices are incorporated into many portable wearable and handheld devices.

Due to the portability necessity of wearable and handheld devices, screen size is a constraining issue on all known wearable and handheld devices. Small screens are highly portable but not practical for most uses and large screens are highly cumbersome. What is needed is a solution that can significantly expand the screen size of wearable and handheld devices without making the devices any larger. The present application discloses a novel solution to multiplying the viewing screen size of wearable and handheld devices tens of times yet not increasing the overall size of the wearable or handheld device at all.

The present invention provides a significant step forward for wearable and handheld devices by integrating into them state of the art projection technology and state of the art image stabilization techniques. The results are small wearable and handheld device which produce large displays projected onto nearly any smooth surface. This enables a large visual presentation from a very small wearable or handheld device.

### BACKGROUND—DESCRIPTION OF PRIOR INVENTION

Many display screens have been described and practiced in the prior art. Such screens are used on many modem conveniences and commonly on wearable and handheld devices including cell phones, personal computers, PDAs, pagers, cameras, video games, audio players, video players, and even print media tablets. One problem is common among nearly all wearable and handheld device display screens. Namely, to keep the devices portable, screen sizes have to be very small. No 1- wearable (operating while being worn by a user) or handheld devices (operating while being held in the hand of a user) that project an image onto a remote surface are known in the prior art. While U.S. Pat. No. 6,091,546 discloses using image stabilization to stabilize an image appearing in eyeglasses that are connected to a cell phone, no wearable or handheld devices that use image stabilization when projecting an image onto a remote (or non-integrated) screen are known in the prior art.

A technique for making relatively small displays produce large images is well know in image projectors. Current state of the art projectors can be quite small yet produce high quality images suitable for large audiences. Additionally, projection is commonly used to make large television viewing surfaces. The technology in projectors has advanced rapidly and significantly in recent years. Currently, high quality images are produced using either CRT or LCD transmissive elements or using reflective elements such as DMLs. Additionally, projected laser light can be used to draw images and new LED colors will improve their uses as lights in projection techniques. In the LCD transmissive approach, light is passed through a LCD which has an image in it. The light picks up the image's colors when passing through the LCD and shines them (projects them) on a screen which is viewed by the audience. In a reflective approach, projection is achieved using a colored filter wheel and tiny mirrors. In the CRT approach, a tiny CRT image is projected onto a screen or viewed through enlarging mirrors. In the laser light projection method, one or more colored lasers rapidly draw the image on a surface where it is viewed by an observer. No example of a wearable and handheld projector is in the prior art. No examples of a wearable and handheld projector which utilizes image stabilization are know in the prior art.

Image stabilization has been brought to a mature technology in modern cameras. Techniques for stabilizing image recordings using digital, optical, and mechanical techniques have been described and practiced in prior art. Both U.S. Pat. No. 5,528,297 Seegert et al and U.S. Pat. No. 5,673,084 Lim et al teach the use of a projector function integrated into a camera. Images recorded by said camera being replayable by the integrated projector. Neither of these patents describe or anticipate image stabilization of the projected image. These integrated projectors are therefore not designed to operate in a wearable and handheld mode. No known prior art utilizes a means for image stabilization in a wearable and handheld device with an integrated means for projection.

The present invention includes a means to project an image from a wearable and handheld device wherein a means to stabilize the projected image is also provided.

### BRIEF SUMMARY

The invention described herein represents a significant improvement for the users of wearable and handheld devices. Heretofore a tradeoff has existed between device portability and screen size. The problem is that a small screen is not conducive to interacting with visual media and a large screen size is not conducive to carrying around. The present invention solves this compromise by keeping the wearable or handheld device small yet enabling the user to produce a large screen display nearly anywhere, anytime, at their convenience.

The invention integrates within the wearable or handheld device a means to project an image onto any remote surface. Further the means of projection is integrated with a means to stabilize the image. The result of this new art is illustrated by a user who is walking around in the city with their handheld cell phone for example. The user points their handheld image projector, (integrated within their cell phone) toward a remote surface (such as a wall) four feet in front of them, activates the projector, and dials up their wireless internet connection. As the user navigates on the internet using buttons on the cell phone, full size web pages are projected from the handheld image projector (cell phone) onto the wall. While the user inadvertently jiggles the projector slightly, the image on the remote surface is stationary. Motion and proximity sensors are integrated into the handheld projector/cell phone which communicate through integrated logic with image stabilizers to stabilize the image's position and size on the remote surface. Image stabilization enables the user to interact with the image projected by their handheld device/cell phone comfortably and efficiently

Thus the present invention offers a significant advancement in visual communications through wearable and handheld devices.

### OBJECTS AND ADVANTAGES

Accordingly, several objects and advantages of my invention are apparent. It is an object of the present invention to provide more portable wearable and handheld devices. It is an object of the present invention to provide a dramatically larger visual image presentation from a wearable and handheld devices. It is an object of the present invention to provide an image that is stable such that the user can interact with the visual information most efficiently. It is an object of the present invention to facilitate a user's ability to interact with high volumes of remote internet visual information wirelessly nearly any place at any time. It is an object of the present invention to provide a means for large interactive graphic presentations nearly anywhere at any time. It is an object of the present invention to provide a means to sense when the wearable and handheld device moves relative to the image. It is an object of the present invention to provide a means to sense the relative distance of the wearable and handheld device relative to a screen onto which it is projecting and image. It is an object of the present invention to use image stabilization techniques to enhance the user's experience with the visual information. IT is an object of th3 present invention to provide an image on a surface that is independent of the system and therefore does not need to be carried by the user of the technology.

Further objects and advantages will become apparent from the enclosed figures and specifications.

### DRAWING FIGURES

FIG. 1 illustrates a means for projecting an image from a handheld device in wireless communication with a computer.

FIG. 2 illustrates a means for projecting an image from a handheld device which produces an image in response to software instructions.

FIG. 3 illustrates a fully assembled handheld cell phone projecting an email image onto a non-integrated remote surface (wall).

FIG. 4 is a flowchart describing both definite and optional elements in the cell phone of FIG. 3.

FIG. 5 illustrates a fully assembled handheld video game projecting a game title image onto a remote non-integrated surface (wall).

FIG. 6 is a flowchart describing both definite and optional elements in the video game of FIG. 5.

FIG. 7 is a flowchart describing a process for projecting, sensing motion relative to, and stabilizing, an image which is projected onto a remote surface from a handheld device.

FIG. 8 illustrates the transmissive means for projecting an image from FIGS. 1 and 2.

FIG. 9 illustrates the means for projecting an image from FIG. 8 except that a mechanical stabilizing means has been activated.

FIG. 10 illustrates the means for projecting an image from FIG. 8 from a different perspective.

FIG. 11 illustrates the means for projecting an image from FIG. 10 except that a mechanical stabilizing means has been activated and a digital stabilizing means has been activated.

FIG. 12 illustrates the means for projecting an image from FIG. 8 with a means for sensing distance from screen emphasized.

FIG. 13 illustrates the means for projecting an image from FIG. 12 except a means for correcting for a change in distance from the screen has been employed.

FIG. 14 illustrates the means for projecting an image from FIG. 8 with a means for sensing motion emphasized.

FIG. 15 illustrates the means for projecting an image from FIG. 14 except a means for correcting for motion has been employed.

FIG. 16 describes a means for projecting an image from a handheld device using a reflective projection means such as a DMD.

FIG. 17 describes a means for projecting an image from a wearable device in wireless communication with a computer using a transmissive projection means such as an LCD.

FIG. 18 describes a means for projecting an image from a wearable device which produces images in response to software instructions, and which comprises a transmissive projection means such as an LCD.

FIG. 19 describes a means for projecting an image from a wearable device which produces images in response to software instructions, and which comprises a reflective projection means such as an DMD.

FIG. 19a describes a means for projecting an image from a wearable device which is in wireless communication with a remote computer, and which comprises a reflective projection means such as a DMD.

FIG. 20 illustrates a user wearing a means for projecting an image.

FIG. 21 illustrates the components of a reflective means to project an image comprising a DMD.

### DETAILED DESCRIPTION OF THE INVENTION

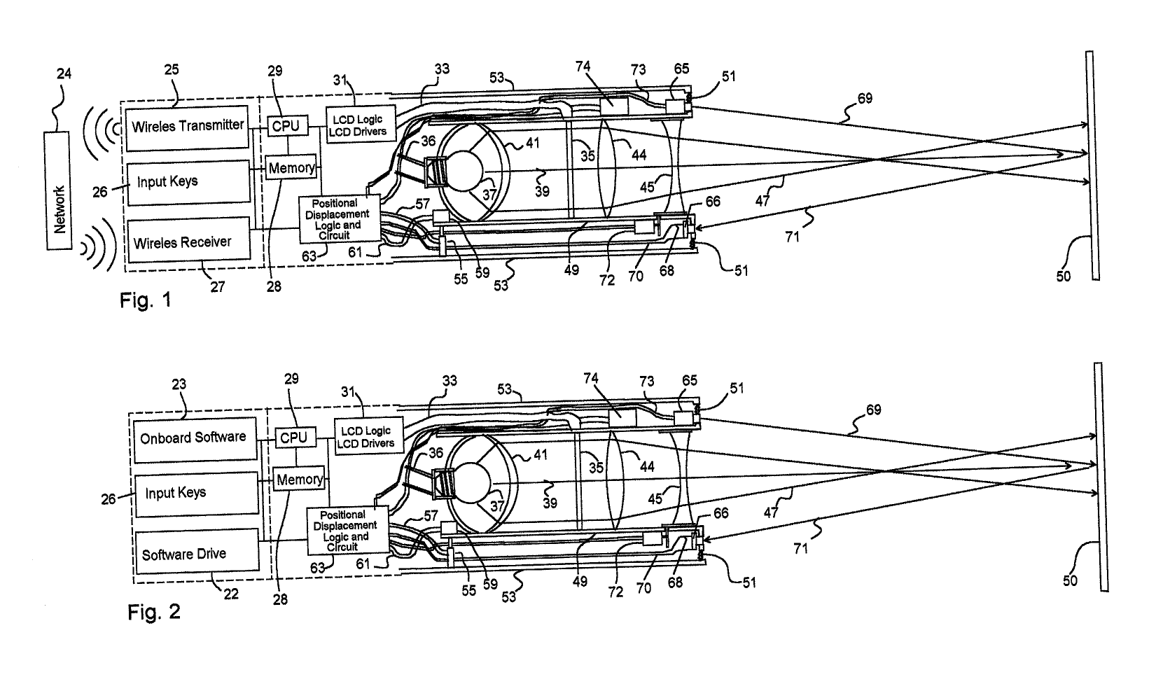

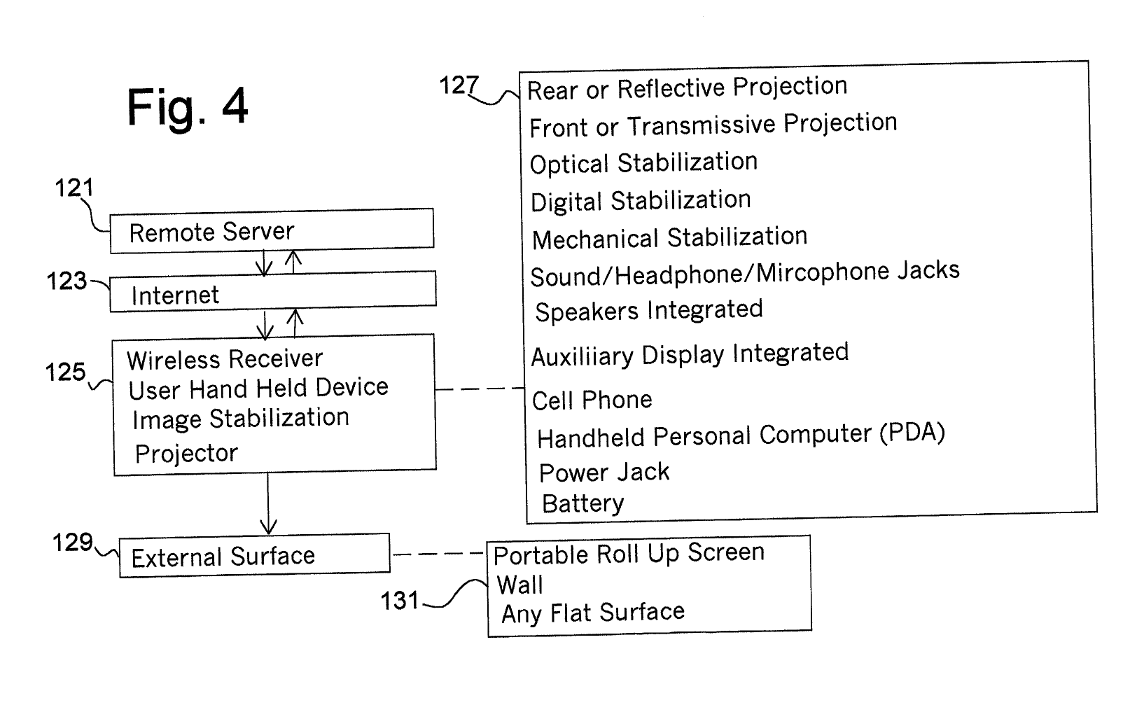

FIG. 1 illustrates a means for projecting an image from a handheld device in wireless communication with a computer. A wireless transmitter 25 sends signals which are carried by a network 24. A receiver 27 receives signals from the network. Such sending and receiving means being those common to cells phones, PDAs and many other hand held devices and comprising a wireless means to communicate with a remote computer. A user is able to input data via input keys 26. A LCD Logic and LCD Drivers 31 (receives input from the cell phone circuitry and CPU and) conveys video image signals to a transparent LCD display 35 via a LCD ribbon cable 33. (As illustrated later, 31 and 35 comprising a digital means to stabilize an image projected from a handheld device.) A light bulb 37 produces bright light 39 which passes through a collimating lens 41. Electricity for 37 being provided by illumination wire 36. When the 39 light passes through the LCD display 35, it becomes colored by passing through the pixels in 35 according to the instructions from 31. The light then passes through a first lens 44 and a second lens 45 which causes the collimated light to travel as exiting rays such as an exiting ray 47 to be displayed as an image on a wall 50. The 37, 41, 35, 44, and 45 elements are housed in a cylinder 49. Said cylinder and its contents together with the 31 comprise a means to project an image. 49 is sealably connected on a first end to a cell phone housing 53 by a flexible seal 51. 49 being connected on a second end to 53 by an actuation cylinder 55. 55 being an electromagnetic actuator powered by actuator wire 57 which carries a charge determined by positional displacement logic and circuit 63 operating in conjunction with 29 and 28. 55 being a mechanical means to stabilize the image projected by a handheld device. 63 receives signals relating to the cell phone's position and movement from an optoelectronic inclination sensor 59, an optical position sensitive detector (PSD) 66, and a piezoelectric accelerometer 74 (examples of each sensor well known in the art and also described in Handbook of Modern Sensors, Fraden, J., 1996, Springer-Verlog, N.Y.) each comprising a means to sense movement of a handheld device relative to an image projected therefrom. The sensing means ride on (and are attached to) the 49 to maximize stabilizing effectiveness and efficiency. Signals to 63 coming from an inclination signal wire 61, a displacement wire 70, and wires from the 74. The 63 relays information to a CPU 29 which compares the information to that stored in a memory 28 and calculates what actions are required to ensure that the image position (on 50) produced by the light emanating from the elements within 49 remains steady. A steady image on 50 enables the user to view the image comfortably and efficiently. 66 senses the handheld unit's position from the image surface by receiving a reflected IR beam 71 reflected off of 50 from an IR LED 65. The 65 and 66 working in conjunction comprise the PSD which determines the handheld device's distance from the image by the principle of triangulation. The 65 sending out and exiting IR beam 69 and the 66 receiving the 71 after it reflects from 50. 66 having a first electric wire 68 and a second electric wire 70. The distance of the handheld unit form the wall being expressed by the intensity of an electric current emanating from 66 and sent to 63. 65 receives its power from an IR LED wire 73. A lens actuation motor 72 when receiving current, turns a gear which actuates a adjustable lens 45. 72 and 45 together being an optical means to stabilize and image projected from a handheld device. The 72 receiving current determined by changes in distance in 50 as sensed by 66. 45 being set within a threaded housing with teeth wherein when the 72 rotates, its gear messes with the teeth of the 45 housing such that it rotates whereupon its threading causes it to move (horizontally in FIG. 1) thereby altering the focal length of the means for projecting an image (as will be discussed later). Note that some of the elements of the cell phone not novel in the present invention have not been reproduced herein to avoid redundancy but the components shown do integrate with the components common to a cell phone. Examples of such components are discussed under FIG. 4 below.

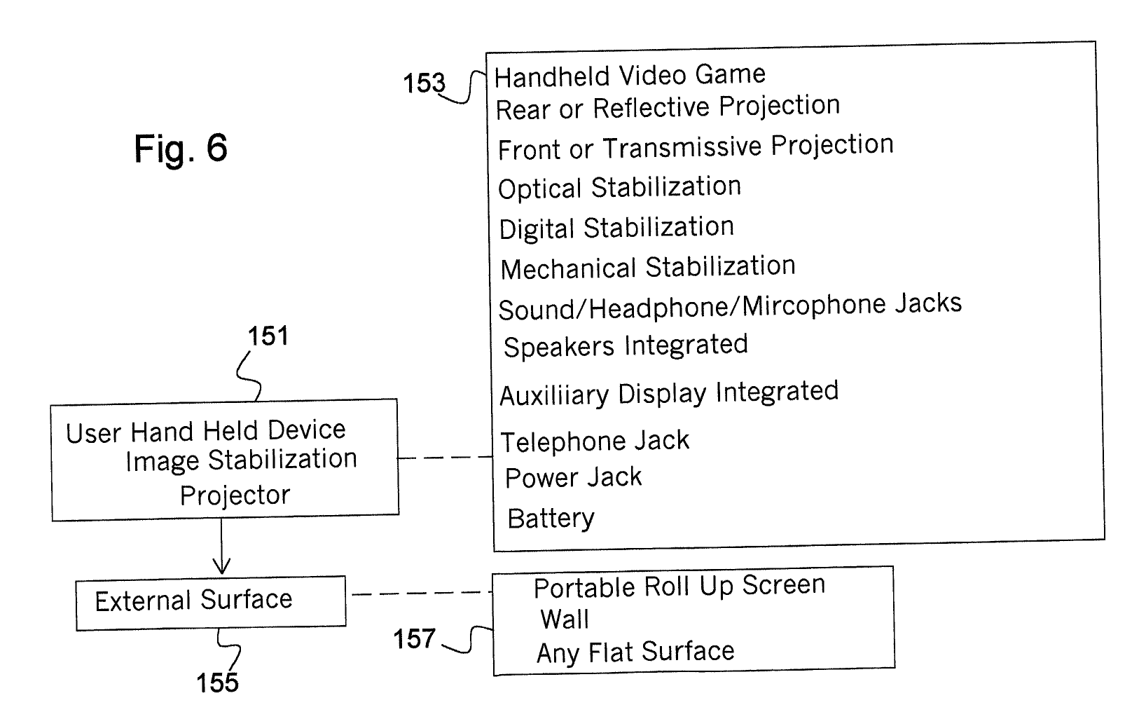

FIG. 2 illustrates a means for projecting an image from a handheld device which produces an image in response to software instructions. Many of the components are identical to those of FIG. 1. Specifically, the means of projection, the means of sensing movement and the means for stabilizing the image are identical to FIG. 1. An onboard set of software instructions 23 working with the 29 instructs the 31 what colors to display in each cell of a 35. Additionally a software drive 22 enables the user to insert new software instructions (such as a new video game) as desired. Software instructions from the 22 being processed by the 29 and passed through the 31 to control the colors displayed on the 35. Note that some of the elements of the hand held display device not novel in the present invention have not been reproduced herein to avoid redundancy but the components shown do integrate with the components common to a such devices. Examples of such components are discussed under FIG. 6 below.

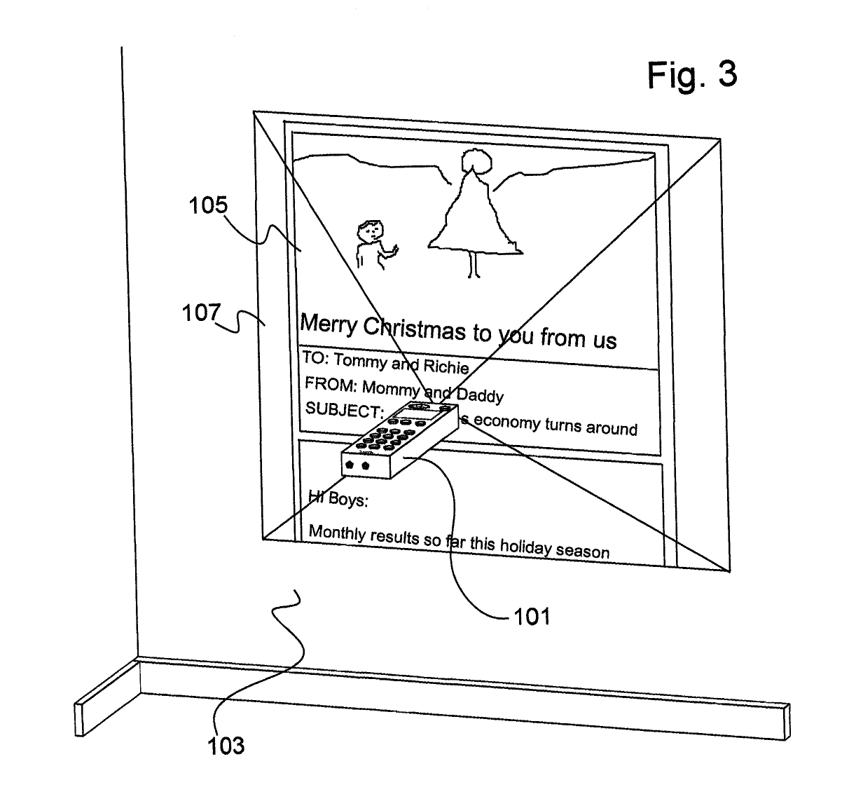

FIG. 3 illustrates a fully assembled handheld cell phone of FIG. 1 projecting an email image onto a non-integrated remote surface (wall). A handheld cell phone 101 is shown fully assembled and comprising a handheld means to project an image. It is equipped with the elements described in FIG. 1. In the illustration, it is producing an image of an email 105 that the user has received. Said image being displayed via projection onto a wall 103 within a building. The background desktop GULI 107 is also being projected by the 101. As the user views this email or navigates elsewhere, the cell phone, using a means to project, a means to sense, and a means to stabilize, projects the image onto the wall, senses cell phone movement, and keeps the image stable.

FIG. 4 is a flowchart describing both definite and optional elements in the cell phone of FIG. 3. A remote server 121 contains content which the user is interested in viewing. The user accesses the 121 through the internet 123 using a wireless receiver (or cell phone) 125. The user pushes buttons on the 125 to interact with the 121 such that the email displayed in FIG. 3 is projected from the handheld device onto an external surface 129. Contained within the 125 are a wireless receiver, image stabilization means (including sensors and logic and circuits), and projection means. Possible options 127 are representative of options that may or may not be contained within the 125. 127 options include; rear or reflective projection, front or transmissive projection, optical stabilization, digital stabilization, mechanical stabilization, sound/headphone/microphone jacks, integrated speakers, auxiliary display integrated, cell phone, handheld personal computer, PDA, power jack, and battery. Likewise, 129 could consist of any of the screen options 131. 131 could be a wall as in illustration FIG. 3 or it can be a portable roll up screen, or any substantially flat surface.

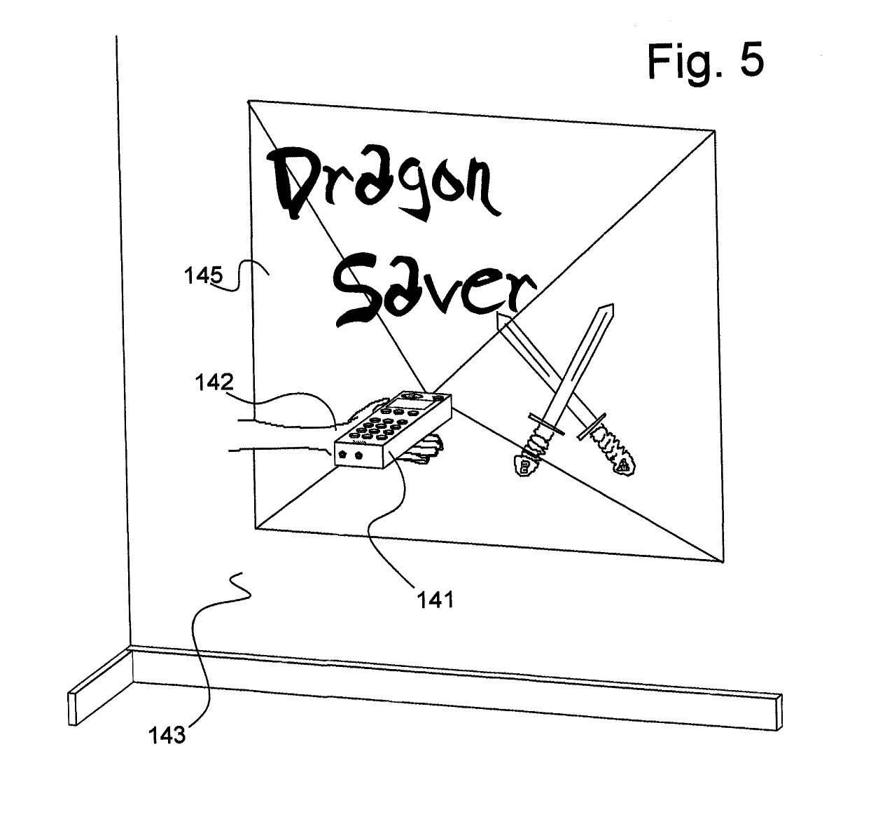

FIG. 5 illustrates a fully assembled handheld video game projecting a game title image onto a remote non-integrated surface (wall). A hand 142 holds the handheld device 141. The 141 comprises the elements of FIG. 2. It produces a projected image of a game 145 onto a remote surface (or wall) 143. The user is able to interact with the game while enjoying a projected, stabilized, large, video image. The 141 comprises a handheld means to project an image onto a remote surface in response to software instructions.

FIG. 6 is a flowchart describing both definite and optional elements in the video game of FIG. 5. The video handheld device 151 contains the means of sensing, image stabilization and projection. It projects an image on an external surface 155. The 151 device may contain any or all of the elements in 153. They include; rear or reflective projection, front or transmissive projection, optical stabilization, digital stabilization, mechanical stabilization, sound/headphone/microphone jacks, integrated speakers, auxiliary display integrated, cell phone, telephone jack, handheld personal computer (PDA), power jack, and battery

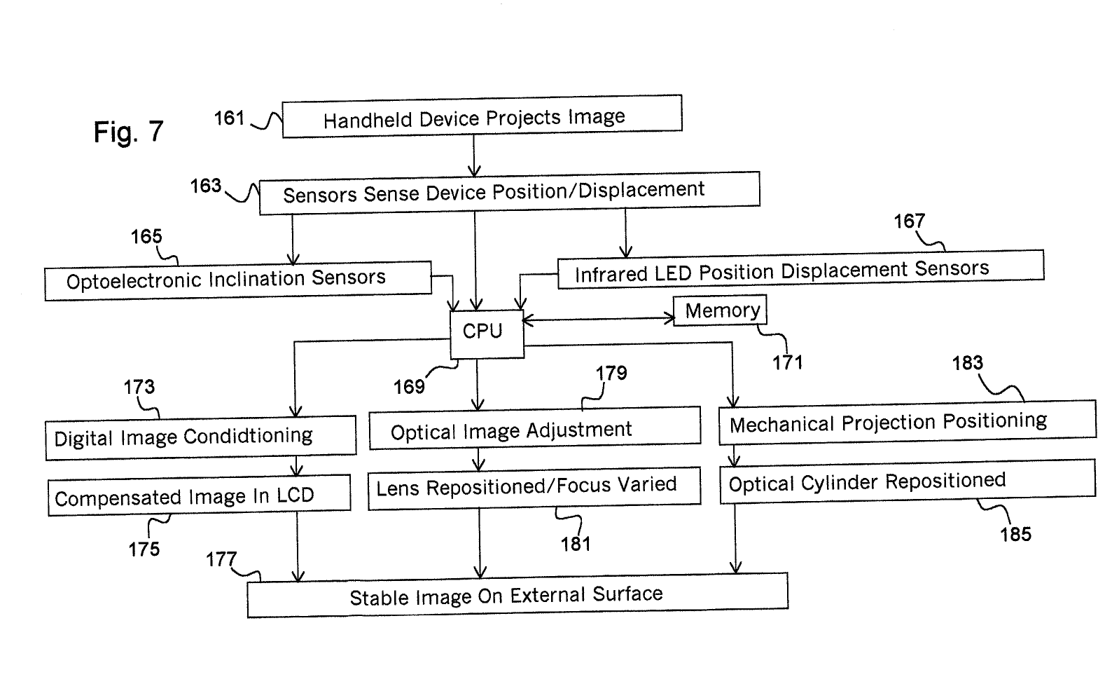

FIG. 7 is a flowchart describing a process for projecting, sensing motion relative to, and stabilizing, an image which is projected onto a remote surface from a handheld device (or wearable device). A handheld device projects an image 161. Sensors sense the device's position changes and displacement 163. 163 reports to a CPU 169. Examples of sensors include a optoelectronic Inclination sensor 165 and an infrared LED position sensitive detector (PSD) 167. 165 and 167 report to the CPU 169. 169 pulls values from memory 171 and also stores information in 171. The CPU calculates what actions must be taken to offset the movements and positions that have been sensed and pulled from memory. It then sends signals to digital image conditioning means 173 (such as a LCD or DMD), optical image adjustment means 179 (such as a variable focus optical system), and/or the mechanical projection positioning means (such as an actuator). Each of these in turn perform functions as specified respectively, compensate image on LCD 175 (or DMD), lens repositioned/focus varied 181, optical cylinder, mechanically repositioned 185. The end result of these actions is a stable image on external surface 177 which can be viewed by a user.

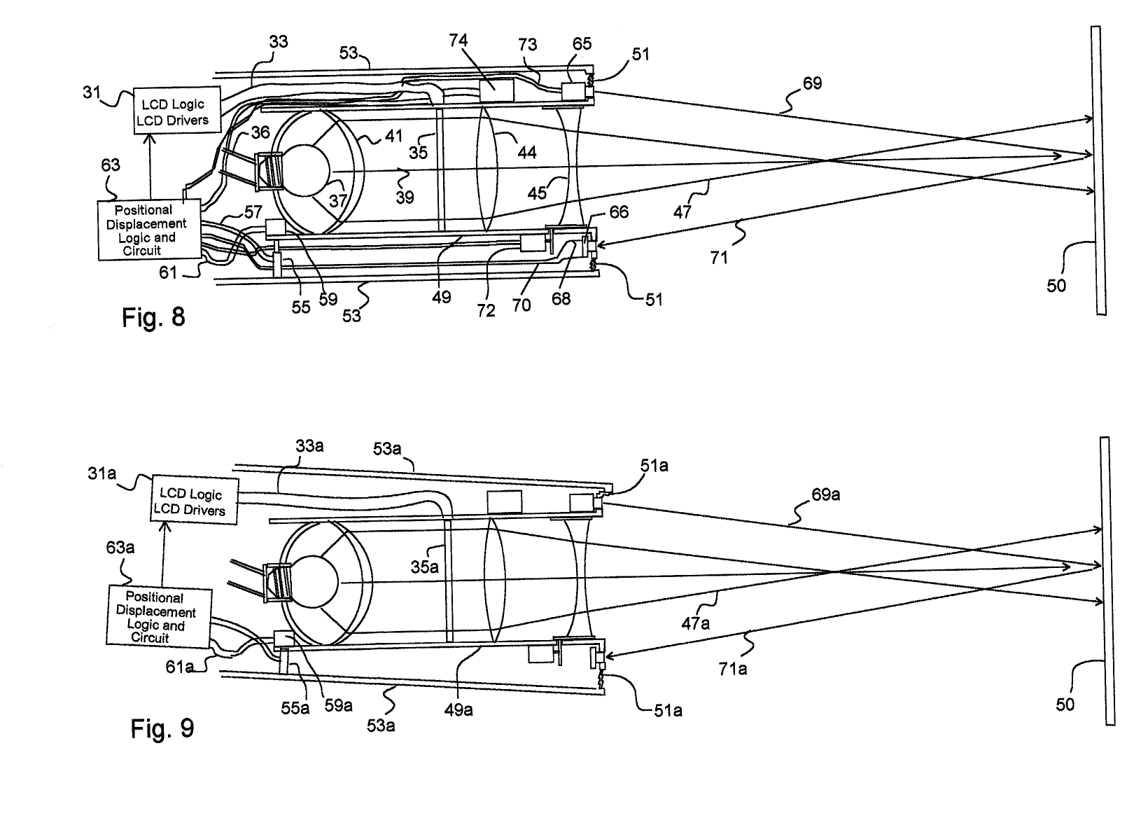

FIG. 8 illustrates the transmissive means for projecting an image of FIGS. 1 and 2.

FIG. 9 illustrates the means for projecting an image from FIG. 8 except that a mechanical stabilizing means has been activated. When the user tilts the cell phone down as illustrated, 59a (optoelectronic inclination sensor) senses the change in tilt and sends a signal to 63a. 63a together with the CPU uses the information together with the distance information from 65 (as reported by 66) to calculate what action is required to keep the image in the same spot on 50 even as the cell phone is tilted. 63a in conjunction with the CPU sends a signal to produce a contracted electric actuation cylinder 55a. 55a being contracted to pull the stabilized cylinder 49a and its image producing elements into the required alignment to stabilize the image for the user. Additionally (as is illustrated in FIG. 11), 63a in conjunction with the CPU uses the sensed information from 65 and 59a to modify the way that the pixels are displayed on the modified LCD 35a via the digitally stabilized LCD Logic LCD Drivers 31a. 65 and 59 each being a means to sense motion of the handheld device and 66 and 55a each being a means to stabilize the image emanating from a handheld device. Thus the user sees an image which is not moved even though the cell phone itself has been moved. A digital means for stabilizing an image from a handheld device being illustrated in 31a in cooperation with 35a and a mechanical/optical means for stabilizing an image from a handheld device being illustrated in 55a. Note that the elements of the cell phone not novel to the present invention have not been reproduced herein to avoid redundancy.

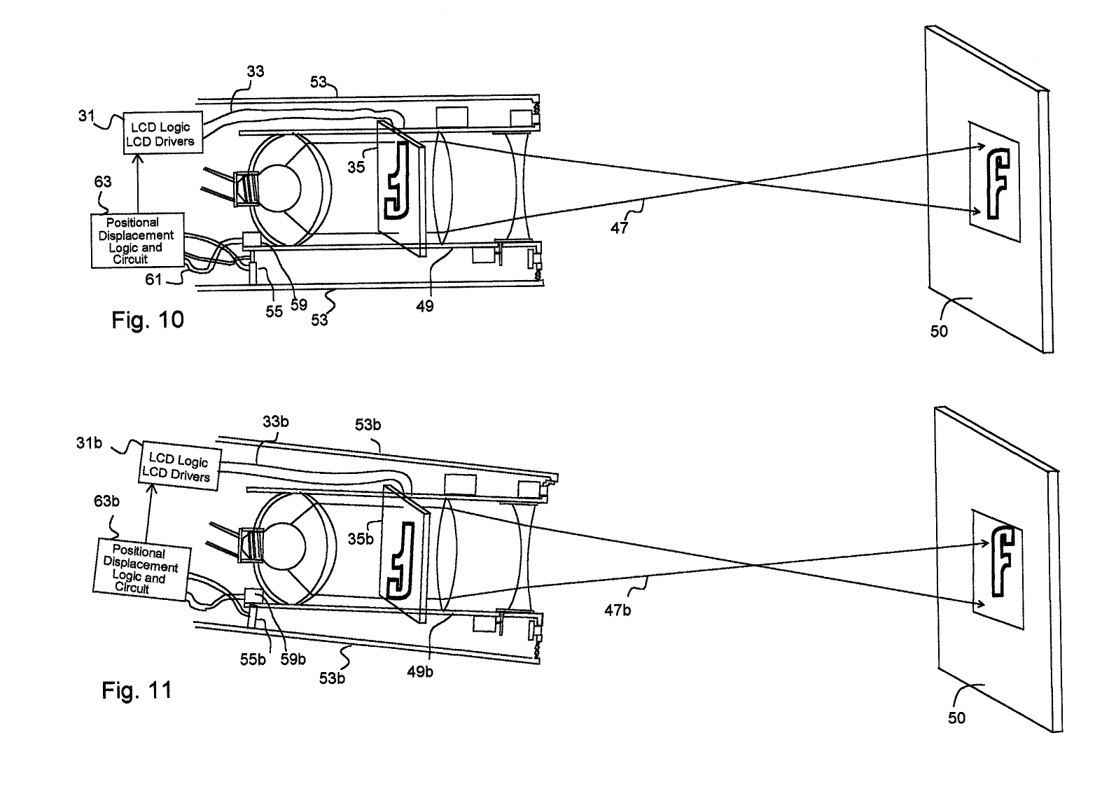

FIG. 10 illustrates the means for projecting an image from FIG. 8 from a different perspective. Namely the LCD is shown three dimensionally with a specific image being produced.

FIG. 11 illustrates the means for projecting an image from FIG. 10 except that a mechanical stabilizing means has been activated and a digital stabilizing means has been activated. As was discussed in FIG. 9, the 55b has been contracted in response to a tilt reported by the 59b. Note that the tilting has also been compensated for by moving the inverted “f” down on at 35b. This is down after the 63b and CPU determines that the tilt can not be adequately compensated for using the contraction at 55b. The “” display on the 50 in FIG. 11 is in the same position as the “f” on 50 of FIG. 10. The 35b operating with the 31b and the CPU comprise a digital means to stabilize an image.

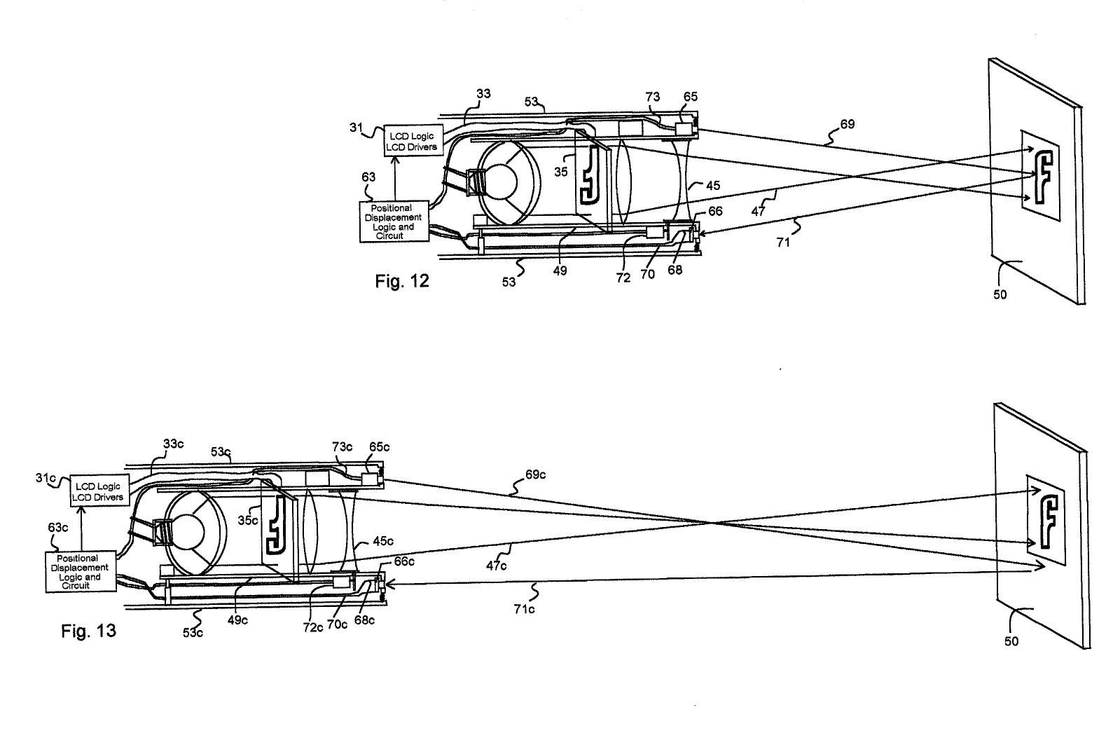

FIG. 12 illustrates the means for projecting an image from FIG. 8 with a means for sensing distance from screen emphasized. Specifically, the 65 IR LED sends the 69 beam to 50 where it reflects as 71 to be received by 66. 66 sends an electric signal to 63 indicative of its proximity to 50. Additionally the lens adjusting motor 72 has 45 positioned in a first position which thereby produces a first focal length on 47 rays and an image size at 50. These are contrasted with FIG. 13 below.

FIG. 13 illustrates the means for projecting an image from FIG. 12 except a means for correcting for a change in proximity to the screen has been employed. Note the handheld device has 10, been moved away from 50 as compared to FIG. 12. This new proximity is detected by 66c which reports the information to 63c in the form of an electric current. 63c in conjunction with the CPU calculates that the 45c lens must be repositioned. A signal is sent from the 63c such that current is sent to 72c. 72c being a motor with a gear which interfaces with the teeth in the mounting unit of 45c. When the 72c gear rotates, it rotates 45c which is caused to move inward. The inward movement of 45c causes the projector's focal length on 47c to lengthen such that the image size of “f” at 50− is the same as the image size “f” of FIG. 13 prior to the handheld devices movement away from 50. Thus an optical means has been employed to stabilize the image from a handheld projection device.

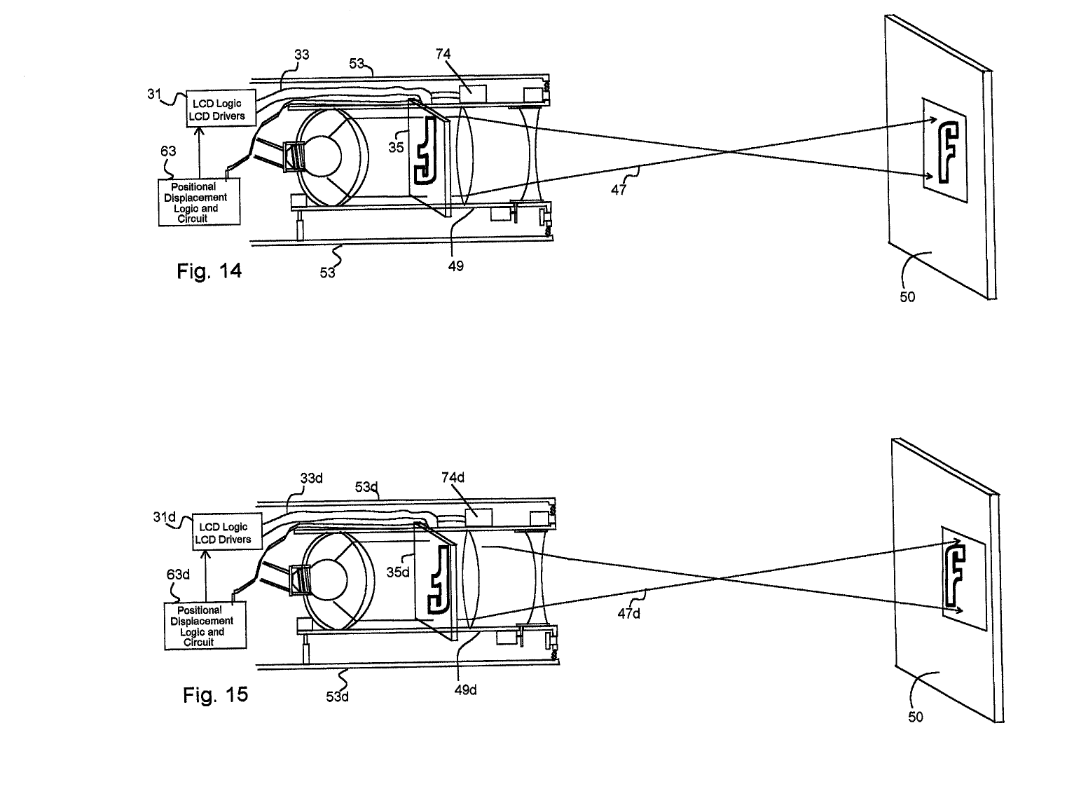

FIG. 14 illustrates the means for projecting an image from FIG. 8 with a means for sensing motion emphasized. The piezoelectric accelerometer 74 is designed to send a signal when it experiences lateral movement as in FIG. 15.

FIG. 15 illustrates the means for projecting an image from FIG. 14 except a means for correcting for motion has been employed. When the 74d detects a movement to the left, is sends a signal to the 63d which together with the CPU calculates that the 31d should reorient to the right of the inverted image of “f” at 35d. Doing so causes the image of “f” at 50 to remain in the same position as shown in FIG. 14. Thus a digital means to stabilize an image from a handheld projector has been demonstrated.

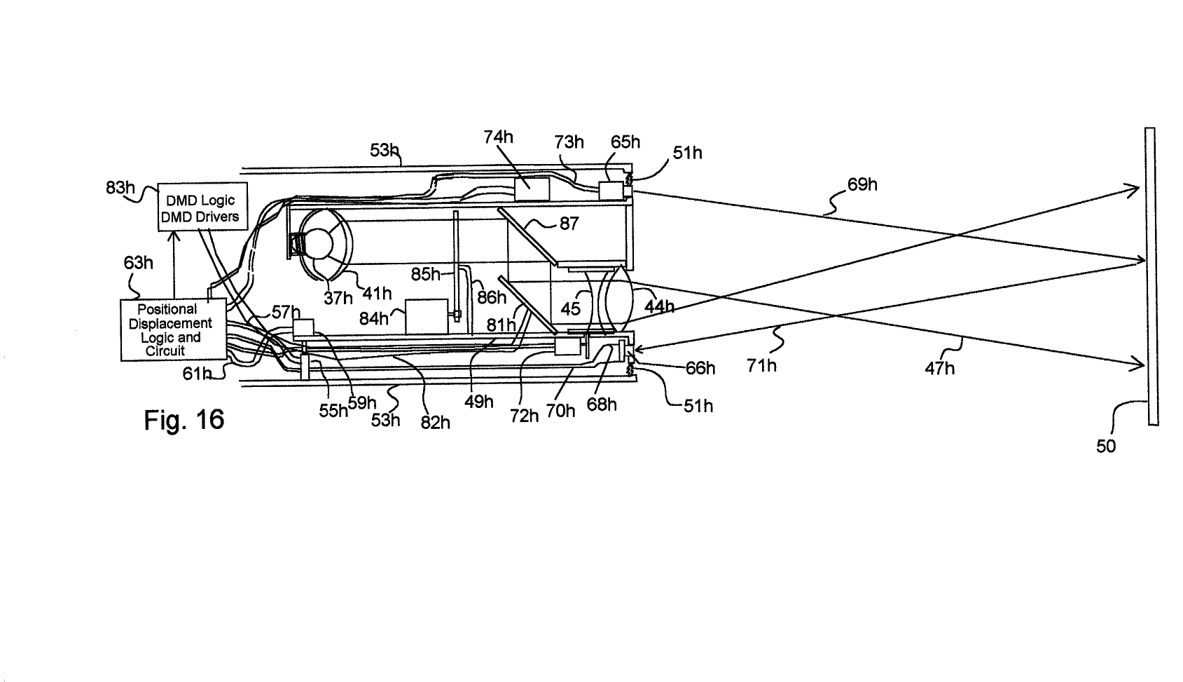

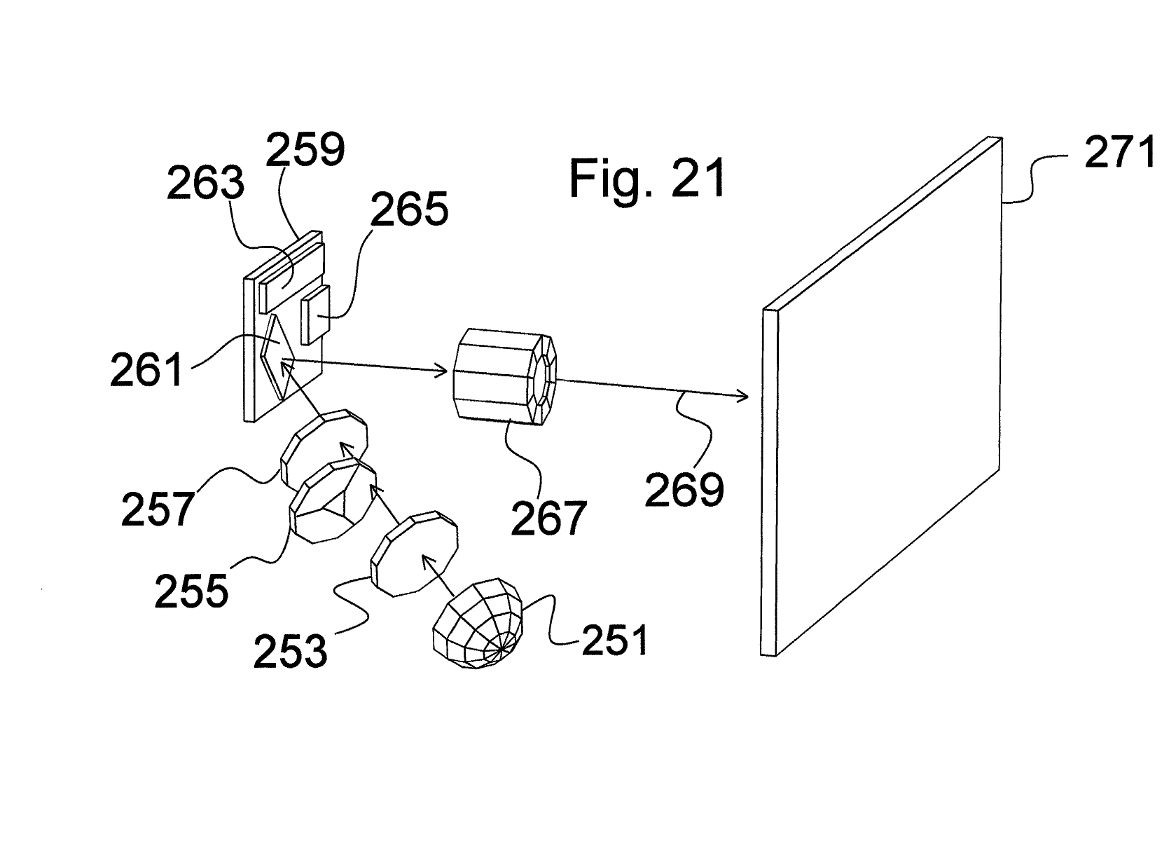

FIG. 16 describes a means for projecting an image from a handheld device using a reflective projection means such as a DMD. Most of the components are he same as those in FIG. 8. The LCD of FIG. 8 has been replaced with a DMD (Digital Micromirror Device). The DMD is described in great detail in FIG. 21. A bulb 37h emits light which is collimated by 41h before it passes though a color wheel 85h. 85h has three filters, one red, one blue, and one green. It spins rapidly such that the light passing therethrough is constantly changing between these three colors. The 85h is rotated by a filter motor 84h and rotates around a support axis 86h. The 84h and 86h being attached to the 49h. a 45 degree mirror reflects the filtered light from the 85h onto a DMD chip at 81h the DMD chip having over 100,000 tiny mirrors (each representative of one pixel) that are actuated according instructions from a DMD Logic DMD Drivers circuitry. The 83h gives instructions to the 81h which represent which colors of light will be reflected when from 81h to produce the image at 50. Note that the same functionality described in FIGS. 1 through 15 can also 19, accompany the DMD version described in FIG. 16. The DMD in conjunction with 83h, 63h and a CPU and a memory is itself a digital means to stabilize an image. The apparatus of FIG. 16 comprises a reflective projection means.

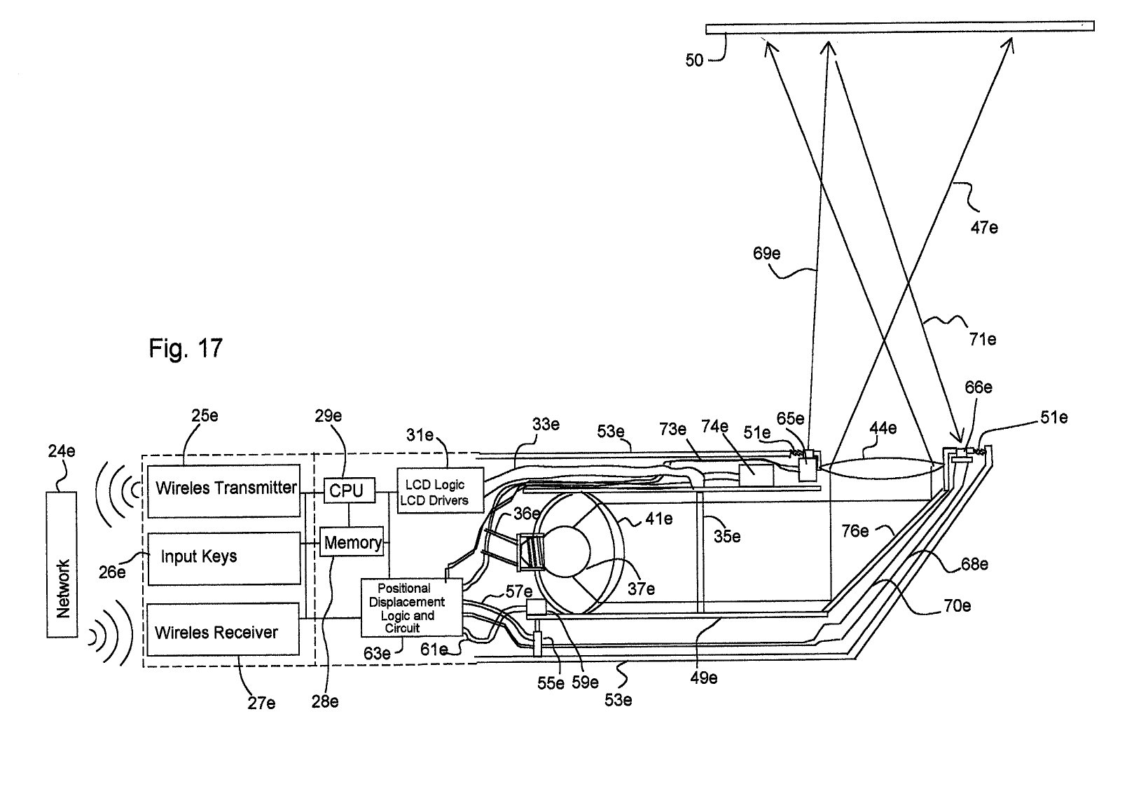

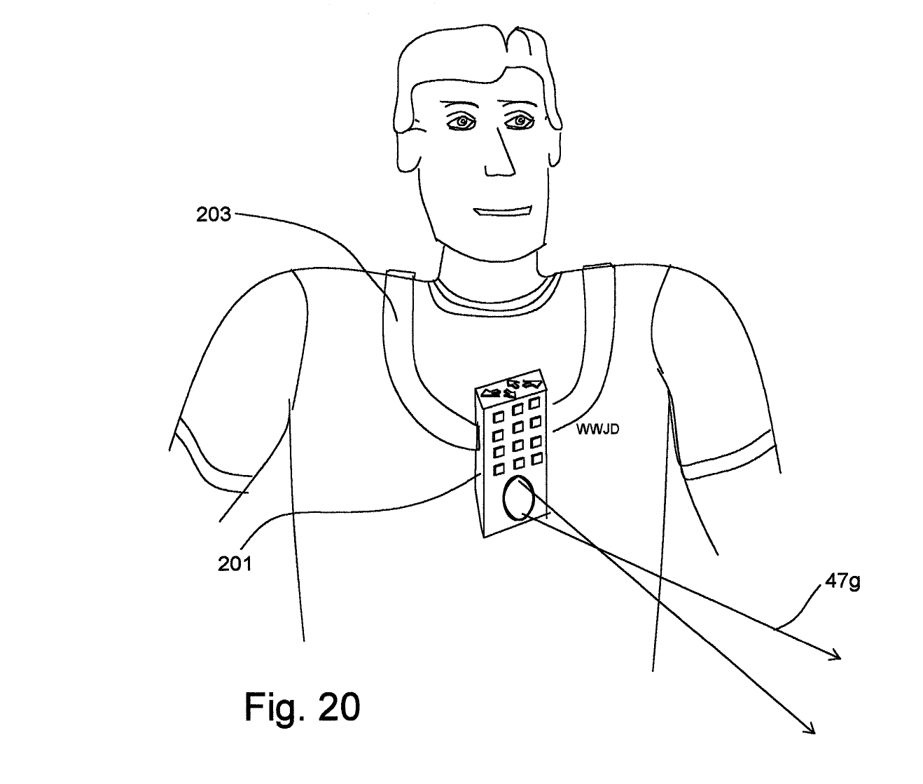

FIG. 17 describes a means for projecting an image from a wearable device in wireless communication with a computer using a transmissive projection means such as an LCD. It comprises functional elements identical to those of FIG. 1 except that a mirror 76e has been added to direct the angle at a right angle from the alignment of the 49e optical cylinder. The device has the same functionality discussed in FIGS. 1, 3, 4, 7-15, except that it is adapted to be a wearable device instead of a handheld device. It is shown being worn in FIG. 20.

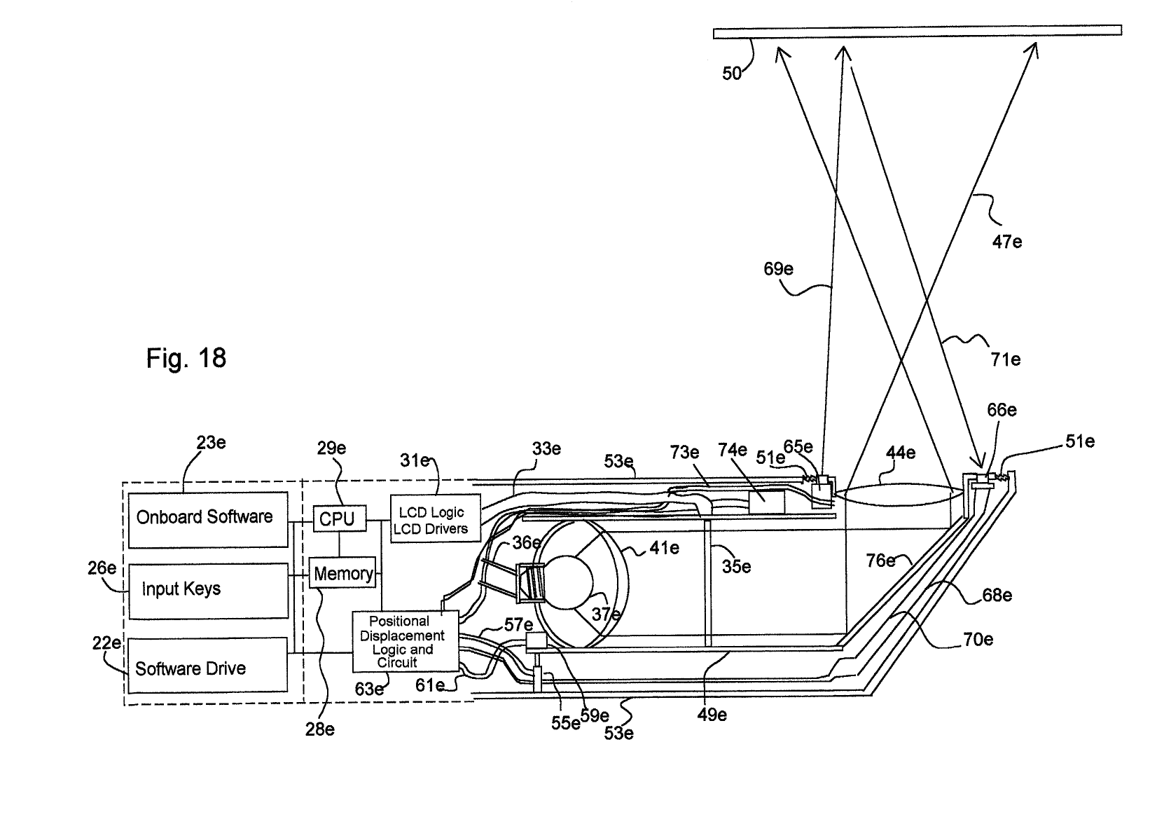

FIG. 18 describes a means for projecting an image from a wearable device which produces images in response to software instructions, and which comprises a transmissive projection means such as an LCD. It comprises functional elements identical to those of FIG. 2 except that a mirror 76e has been added to direct the angle at a right angle from the alignment of the 49e optical cylinder. The device has the same functionality discussed in FIGS. 2, 5, 6, 7-15, except that it is adapted to be a wearable device instead of a handheld device. It is shown being worn in FIG. 20.

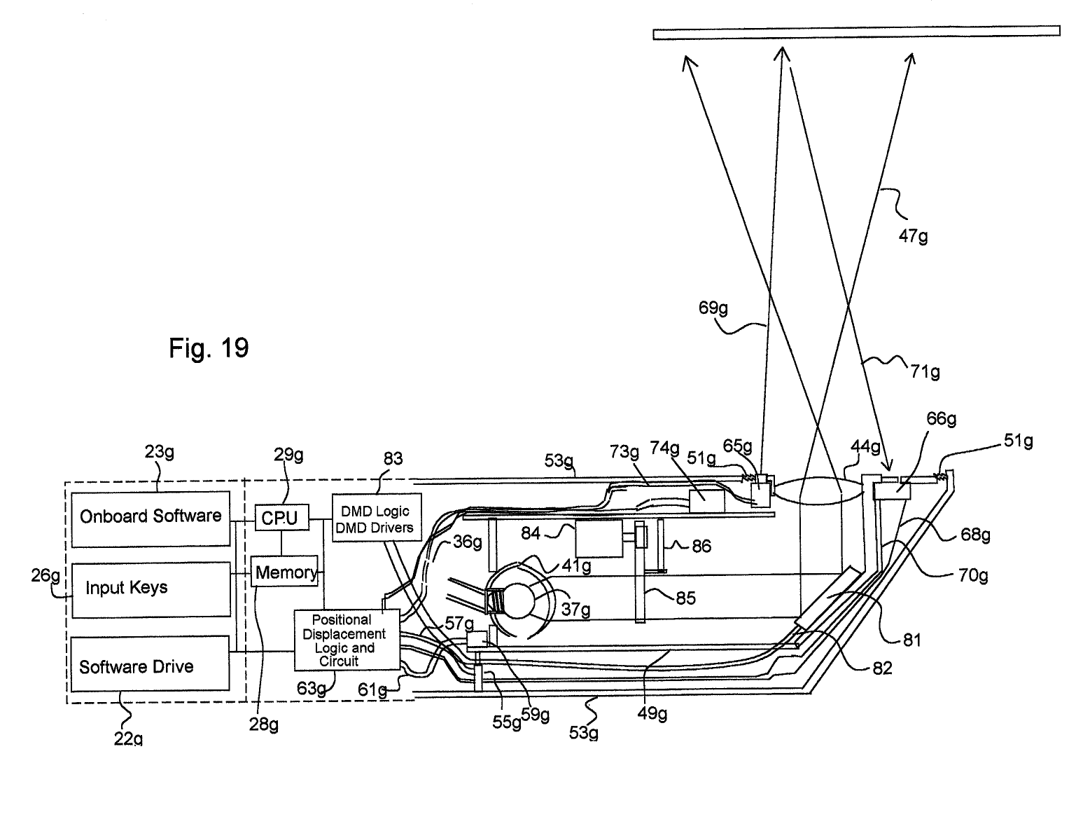

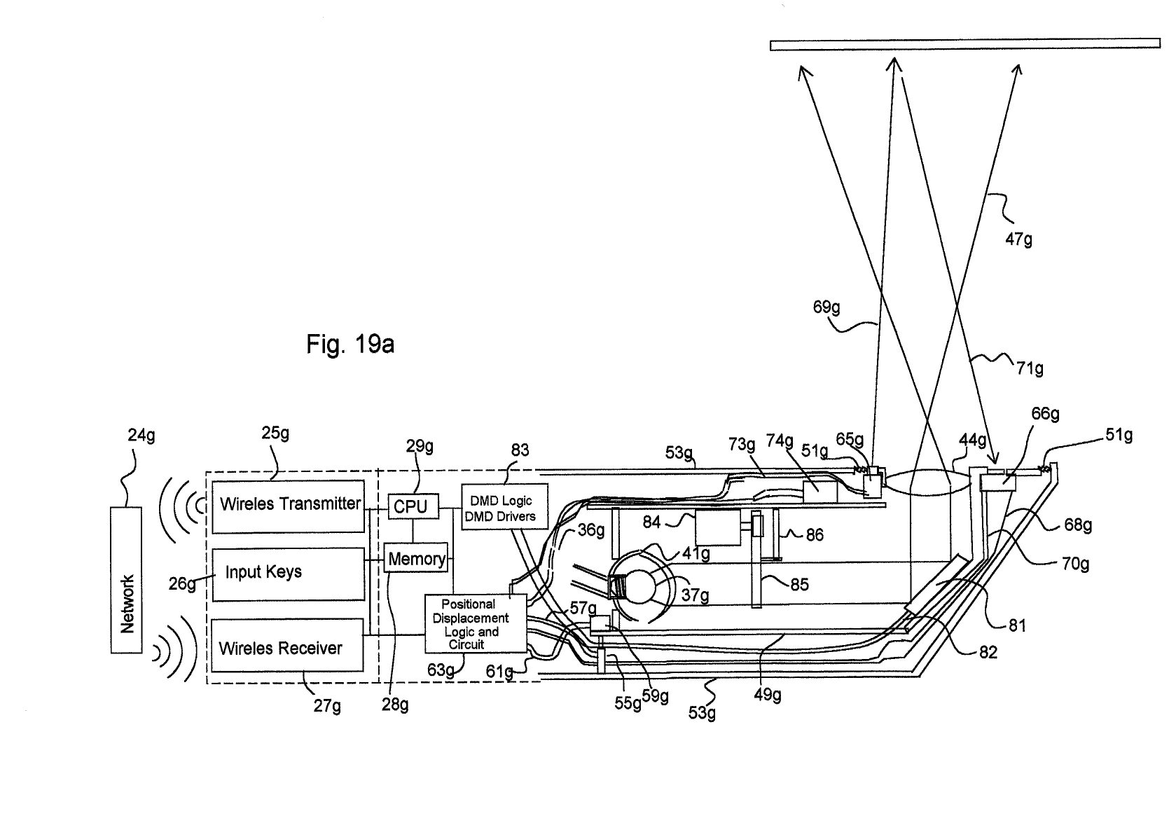

FIG. 19 describes a means for projecting an image from a wearable device which produces images in response to software instructions, and which comprises a reflective projection means such as an DMD. The architecture is identical to that of FIG. 16 except that it has been adapted to be worn, primarily by the removal of the 87 component such that light exits at a right angle to the optical cylinder, also 81 being the DMD chip. The elements of FIG. 19 comprises functional elements identical to those of FIG. 2 except that a mirror 76e has been added to direct the angle at a right angle from the alignment of the 49e optical cylinder. The device has the same functionality discussed in FIGS. 2, 5, 6, 7-15, except that it is adapted to be a wearable device instead of a handheld device. It is shown being worn in FIG. 20.

FIG. 19a describes a means for projecting an image from a wearable device which is in wireless communication with a remote computer, and which comprises a reflective projection means such as a DMD. The architecture is identical to that of FIG. 19 except that it is communicating with a remote computer via a network. The device has the same functionality discussed in FIGS. 1, 3, 4, 7-15, except that it is adapted to be a wearable device instead of a handheld device. It is shown being worn in FIG. 20.

FIG. 20 illustrates a user wearing a means for projecting an image. The device being worn can be that of FIGS. 17, 18, 19, and/or 19a. A fully assembled unit wearable image projector 201 emits a projected image including ray 47g. The device is attached to a strap 203 which is worn by a user.

FIG. 21 illustrates the components of a reflective means to project an image comprising a DMD. FIGS. 16, 19 and 19a use the DMD elements of FIG. 21. a light source 251 emits light which is condensed at 253 and 257. The light passes though a rapidly spinning color filter 255. The color filter having red, green, and blue sections. The DM1 mirrors 261 are a vast array of tiny mirrors each with electronic actuators all mounted onto a DLP Board 259. A processor 263 in combination with memory 265 control the position of each mirror at any given moment such that a coherent color image 269 is projected from a 267 lens onto a surface 271.

Operation of the Invention

FIG. 1 illustrates a means for projecting an image from a handheld device in wireless communication with a computer. A wireless transmitter 25 sends signals which are carried by a network 24. A receiver 27 receives signals from the network. Such sending and receiving means being those common to cells phones, PDAs and many other hand held devices and comprising a wireless means to communicate with a remote computer. A user is able to input data via input keys 26. A LCD Logic and LCD Drivers 31 (receives input from the cell phone circuitry and CPU and) conveys video image signals to a transparent LCD display 35 via a LCD ribbon cable 33. (As illustrated later, 31 and 35 comprising a digital means to stabilize an image projected from a handheld device.) A light bulb 37 produces bright light 39 which passes through a collimating lens 41. Electricity for 37 being provided by illumination wire 36. When the 39 light passes through the LCD display 35, it becomes colored by passing through the pixels in 35 according to the instructions from 31. The light then passes through a first lens 44 and a second lens 45 which causes the collimated light to travel as exiting rays such as an exiting ray 47 to be displayed as an image on a wall 50. The 37, 41, 35, 44, and 45 elements are housed in a cylinder 49. Said cylinder and its contents together with the 31 comprise a means to project an image. 49 is sealably connected on a first end to a cell phone housing 53 by a flexible seal 51. 49 being connected on a second end to 53 by an actuation cylinder 55. 55 being an electromagnetic actuator powered by actuator wire 57 which carries a charge determined by positional displacement logic and circuit 63 operating in conjunction with 29 and 28. 55 being a mechanical means to stabilize the image projected by a handheld device. 63 receives signals relating to the cell phone's position and movement from an optoelectronic inclination sensor 59, an optical position sensitive detector (PSD) 66, and a piezoelectric accelerometer 74 (examples of each sensor well known in the art and also described in Handbook of Modern Sensors, Fraden, J., 1996, Springer-Verlog, N.Y.) each comprising a means to sense movement of a handheld device relative to an image projected therefrom. The sensing means ride on (and are attached to) the 49 to maximize stabilizing effectiveness and efficiency. Signals to 63 coming from an inclination signal wire 61, a displacement wire 70, and wires from the 74. The 63 relays information to a CPU 29 which compares the information to that stored in a memory 28 and calculates what actions are required to ensure that the image position(on 50) produced by the light emanating from the elements within 49 remains steady. A steady image on 50 enables the user to view the image comfortably and efficiently. 66 senses the handheld unit's position from the image surface by receiving a reflected IR beam 71 reflected off of 50 from an IR LED 65. The 65 and 66 working in conjunction comprise the PSD which determines the handheld device's distance from the image by the principle of triangulation. The 65 sending out and exiting IR beam 69 and the 66 receiving the 71 after it reflects from 50. 66 having a first electric wire 68 and a second electric wire 70. The distance of the handheld unit form the wall being expressed by the intensity of an electric current emanating from 66 and sent to 63. 65 receives its power from an IR LED wire 73. A lens actuation motor 72 when receiving current, turns a gear which actuates a adjustable lens 45. 72 and 45 together being an optical means to stabilize and image projected from a handheld device. The 72 receiving current determined by changes in distance in 50 as sensed by 66. 45 being set within a threaded housing with teeth wherein when the 72 rotates, its gear messes with the teeth of the 45 housing such that it rotates whereupon its threading causes it to move (horizontally in FIG. 1) thereby altering the focal length of the means for projecting an image (as will be discussed later). Note that some of the elements of the cell phone not novel in the present invention have not been reproduced herein to avoid redundancy but the components shown do integrate with the components common to a cell phone. Examples of such components are discussed under FIG. 4 below.

FIG. 2 illustrates a means for projecting an image from a handheld device which produces an image in response to software instructions. Many of the components are identical to those of FIG. 1. Specifically, the means of projection, the means of sensing movement and the means for stabilizing the image are identical to FIG. 1. An onboard set of software instructions 23 working with the 29 instructs the 31 what colors to display in each cell of a 35. Additionally a software drive 22 enables the user to insert new software instructions (such as a new video game) as desired. Software instructions from the 22 being processed by the 29 and passed through the 31 to control the colors displayed on the 35. Note that some of the elements of the hand held display device not novel in the present invention have not been reproduced herein to avoid redundancy but the components shown do integrate with the components common to a such devices. Examples of such components are discussed under FIG. 6 below.

FIG. 3 illustrates a fully assembled handheld cell phone of FIG. 1 projecting an email image onto a non-integrated remote surface (wall). A handheld cell phone 101 is shown fully assembled and comprising a handheld means to project an image. It is equipped with the elements described in FIG. 1. In the illustration, it is producing an image of an email 105 that the user has received. Said image being displayed via projection onto a wall 103 within a building. The background desktop GULI 107 is also being projected by the 101. As the user views this email or navigates elsewhere, the cell phone, using a means to project, a means to sense, and a means to stabilize, projects the image onto the wail, senses cell phone movement, and keeps the image stable.

FIG. 4 is a flowchart describing both definite and optional elements in the cell phone of FIG. 3. A remote server 121 contains content which the user is interested in viewing. The user accesses the 121 through the internet 123 using a wireless receiver (or cell phone) 125. The user pushes buttons on the 125 to interact with the 121 such that the email displayed in FIG. 3 is projected from the handheld device onto an external surface 129. Contained within the 125 are a wireless receiver, image stabilization means (including sensors and logic and circuits), and projection means. Possible options 127 are representative of options that may or may not be contained within the 125. 127 options include; rear or reflective projection, front or transmissive projection, optical stabilization, digital stabilization, mechanical stabilization, sound/headphone/microphone jacks, integrated speakers, auxiliary display integrated, cell phone, handheld personal computer, PDA, power jack, and battery. Likewise, 129 could consist of any of the screen options 131. 131 could be a wall as in illustration FIG. 3 or it can be a portable roll up screen, or any substantially flat surface.

FIG. 5 illustrates a fully assembled handheld video game projecting a game title image onto a remote non-integrated surface (wall). A hand 142 holds the handheld device 141. The 141 comprises the elements of FIG. 2. It produces a projected image of a game 145 onto a remote surface (or wall) 143. The user is able to interact with the game while enjoying a projected, stabilized, large, video image. The 141 comprises a handheld means to project an image onto a remote surface in response to software instructions.

FIG. 6 is a flowchart describing both definite and optional elements in the video game of FIG. 5. The video handheld device 151 contains the means of sensing, image stabilization and projection. It projects an image on an external surface 155. The 151 device may contain any or all of the elements in 153. They include; rear or reflective projection, front or transmissive projection, optical stabilization, digital stabilization, mechanical stabilization, sound/headphone/microphone jacks, integrated speakers, auxiliary display integrated, cell phone, telephone jack, handheld personal computer (PDA), power jack, and battery

FIG. 7 is a flowchart describing a process for projecting, sensing motion relative to, and stabilizing, an image which is projected onto a remote surface from a handheld device (or wearable device). A handheld device projects an image 161. Sensors sense the device's position changes and displacement 163. 163 reports to a CPU 169. Examples of sensors include a optoelectronic Inclination sensor 165 and an infrared LED position sensitive detector (PSD) 167. 165 and 167 report to the CPU 169. 169 pulls values from memory 171 and also stores information in 171. The CPU calculates what actions must be taken to offset the movements and positions that have been sensed and pulled from memory. It then sends signals to digital image conditioning means 173 (such as a LCD or DMD), optical image adjustment means 179 (such as a variable focus optical system), and/or the mechanical projection positioning means (such as an actuator). Each of these in turn perform functions as specified respectively, compensate image on LCD 175 (or DMD), lens repositioned/focus varied 181, optical cylinder, mechanically repositioned 185. The end result of these actions is a stable image on external surface 177 which can be viewed by a user.

FIG. 8 illustrates the transmissive means for projecting an image of FIGS. 1 and 2.

FIG. 9 illustrates the means for projecting an image from FIG. 8 except that a mechanical stabilizing means has been activated. When the user tilts the cell phone down as illustrated, 59a (optoelectronic inclination sensor) senses the change in tilt and sends a signal to 63a. 63a together with the CPU uses the information together with the distance information from 65 (as reported by 66) to calculate what action is required to keep the image in the same spot on 50 even as the cell phone is tilted. 63a in conjunction with the CPU sends a signal to produce a contracted electric actuation cylinder 55a. 55a being contracted to pull the stabilized cylinder 49a and its image producing elements into the required alignment to stabilize the image for the user. Additionally (as is illustrated in FIG. 11), 63a in conjunction with the CPU uses the sensed information from 65 and 59a to modify the way that the pixels are displayed on the modified LCD 35a via the digitally stabilized LCD Logic LCD Drivers 31a. 65 and 59 each being a means to sense motion of the handheld device and 66 and 55a each being a means to stabilize the image emanating from a handheld device. Thus the user sees an image which is not moved even though the cell phone itself has been moved. A digital means for stabilizing an image from a handheld device being illustrated in 31 a in cooperation with 35a and a mechanical/optical means for stabilizing an image from a handheld device being illustrated in 55a. Note that the elements of the cell phone not novel to the present invention have not been reproduced herein to avoid redundancy.

FIG. 10 illustrates the means for projecting an image from FIG. 8 from a different perspective. Namely the LCD is shown three dimensionally with a specific image being produced.

FIG. 11 illustrates the means for projecting an image from FIG. 10 except that a mechanical stabilizing means has been activated and a digital stabilizing means has been activated. As was discussed in FIG. 9, the 55b has been contracted in response to a tilt reported by the 59b. Note that the tilting has also been compensated for by moving the inverted “f” down on at 35b. This is down after the 63b and CPU determines that the tilt can not be adequately compensated for using the contraction at 55b. The “” display on the 50 in FIG. 11 is in the same position as the “f” on 50 of FIG. 10. The 35b operating with the 31b and the CPU comprise a digital means to stabilize an to image.

FIG. 12 illustrates the means for projecting an image from FIG. 8 with a means for sensing distance from screen emphasized. Specifically, the 65 IR LED sends the 69 beam to 50 where it reflects as 71 to be received by 66. 66 sends an electric signal to 63 indicative of its proximity to 50. Additionally the lens adjusting motor 72 has 45 positioned in a first position which thereby produces a first focal length on 47 rays and an image size at 50. These are contrasted with FIG. 13 below.

FIG. 13 illustrates the means for projecting an image from FIG. 12 except a means for correcting for a change in proximity to the screen has been employed. Note the handheld device has been moved away from 50 as compared to FIG. 12. This new proximity is detected by 66c which reports the information to 63c in the form of an electric current. 63c in conjunction with the CPU calculates that the 45c lens must be repositioned. A signal is sent from the 63c such that current is sent to 72c. 72c being a motor with a gear which interfaces with the teeth in the mounting unit of 45c. When the 72c gear rotates, it rotates 45c which is caused to move inward. The inward movement of 45c causes the projector's focal length on 47c to lengthen such that the image size of “f” at 50− is the same as the image size “f” of FIG. 13 prior to the handheld devices movement away from 50. Thus an optical means has been employed to stabilize the image from a handheld projection device.

FIG. 14 illustrates the means for projecting an image from FIG. 8 with a means for sensing motion emphasized. The piezoelectric accelerometer 74 is designed to send a signal when it experiences lateral movement as in FIG. 15.

FIG. 15 illustrates the means for projecting an image from FIG. 14 except a means for correcting for motion has been employed. When the 74d detects a movement to the left, is sends a signal to the 63d which together with the CPU calculates that the 31d should reorient to the right of the inverted image of “f” at 35d. Doing so causes the image of “f” at 50 to remain in the same position as shown in FIG. 14. Thus a digital means to stabilize an image from a handheld projector has been demonstrated.

FIG. 16 describes a means for projecting an image from a handheld device using a reflective projection means such as a DMD. Most of the components are he same as those in FIG. 8. The LCD of FIG. 8 has been replaced with a DMD (Digital Micromirror Device). The DMD is described in great detail in FIG. 21. A bulb 37h emits light which is collimated by 41h before it passes though a color wheel 85h. 85h has three filters, one red, one blue, and one green. It spins rapidly such that the light passing therethrough is constantly changing between these three colors. The 85h is rotated by a filter motor 84h and rotates around a support axis 86h. The 84h and 86h being attached to the 49h. a 45 degree mirror reflects the filtered light from the 85h onto a DMD chip at 81h the DMD chip having over 100,000 tiny mirrors (each representative of one pixel) that are actuated according instructions from a DMD Logic DMD Drivers circuitry. The 83h gives instructions to the 81h which represent which colors of light will be reflected when from 81h to produce the image at 50. Note that the same functionality described in FIGS. 1 through 15 can also accompany the DMD version described in FIG. 16. The DMD in conjunction with 83h, 63h and a CPU and a memory is itself a digital means to stabilize an image. The apparatus of FIG. 16 comprises a reflective projection means.

FIG. 17 describes a means for projecting an image from a wearable device in wireless communication with a computer using a transmissive projection means such as an LCD. It comprises functional elements identical to those of FIG. 1 except that a mirror 76e has been added to direct the angle at a right angle from the alignment of the 49e optical cylinder. The device has the same functionality discussed in FIGS. 1, 3, 4, 7-15, except that it is adapted to be a wearable device instead of a handheld device. It is shown being worn in FIG. 20.

FIG. 18 describes a means for projecting an image from a wearable device which produces images in response to software instructions, and which comprises a transmissive projection means such as an LCD. It comprises functional elements identical to those of FIG. 2 except that a mirror 76e has been added to direct the angle at a right angle from the alignment of the 49e optical cylinder. The device has the same functionality discussed in FIGS. 2, 5, 6, 7-15, except that it is adapted to be a wearable device instead of a handheld device. It is shown being worn in FIG. 20.

FIG. 19 describes a means for projecting an image from a wearable device which produces images in response to software instructions, and which comprises a reflective projection means such as an DMD. The architecture is identical to that of FIG. 16 except that it has been adapted to be worn, primarily by the removal of the 87 component such that light exits at a right angle to the optical cylinder, also 81 being the DMD chip. The elements of FIG. 19 comprises functional elements identical to those of FIG. 2 except that a mirror 76e has been added to direct the angle at a right angle from the alignment of the 49e optical cylinder. The device has the same functionality discussed in FIGS. 2, 5, 6, 7-15, except that it is adapted to be a wearable device instead of a handheld device. It is shown being worn in FIG. 20.

FIG. 19a describes a means for projecting an image from a wearable device which is in wireless communication with a remote computer, and which comprises a reflective projection means such as a DMD. The architecture is identical to that of FIG. 19 except that it is communicating with a remote computer via a network. The device has the same functionality discussed in FIG. 1, 3, 4, 7-15, except that it is adapted to be a wearable device instead of a handheld device. It is shown being worn in FIG. 20.

FIG. 20 illustrates a user wearing a means for projecting an image. The device being worn can be that of FIGS. 17, 18, 19, and/or 19a. A fully assembled unit wearable image projector 201 emits a projected image including ray 47g. The device is attached to a strap 203 which is worn by a user.

FIG. 21 illustrates the components of a reflective means to project an image comprising a DMD. FIGS. 16, 19 and 19a use the DMD elements of FIG. 21. a light source 251 emits light which is condensed at 253 and 257. The light passes though a rapidly spinning color filter 255. The color filter having red, green, and blue sections. The DMD mirrors 261 are a vast array of tiny mirrors each with electronic actuators all mounted onto a DLP Board 259. A processor 263 in combination with memory 265 control the position of each mirror at any given moment such that a coherent color image 269 is projected from a 267 lens onto a surface 271.

Conclusion, Ramifications, and Scope

Thus the reader will see that the handheld and wearable devices with integrated projector of this invention provide a novel unanticipated, highly functional and reliable means for using optical and electronic technologies to vastly improve the visual display performance of many handheld and/or wearable devices.

While my above description describes many specifications, these should not be construed as limitations on the scope of the invention, but rather as an exemplification of a preferred embodiment thereof. Many other variations are possible. For example, many techniques for projecting images are well known and could be used by one skilled in the art, some specific examples include using LED light sources such as with U.S. Pat. No. 6,224,216 and a laser light source such as with U.S. Pat. No. 6,170,953. Many optical elements and combinations thereof are possible. Many position sensing and displacement sensing techniques are known that could be used herein. Many image stabilizing techniques are known including digital, optical, and mechanical that could be used herein. Many functions can be performed by handheld and wearable devices which have not been enumerated herein, it will be understood that the present invention can be used with any handheld or wearable device which can benefit from improved presentation of visual media. Some of the functioning elements of the specific handheld devices have not been reproduced herein but the devices shown are assumed to include elements common to these devices, some examples include batteries, additional software drives, and jacks.

I claim:

1. A visual information display system, comprising,
a means for projecting an image onto a surface,
a means for sensing motion of said means for projecting relative to said surface, and
a means for compensating for said motion such that said image is maintained in a stable position on said surface.

2. The visual information display system of claim 1 wherein said means for projecting is configured to be operated while being worn by a user.

3. The visual display system of claim 1 wherein said means for projecting comprises a transmissive projection means.

4. The visual display system of claim 1 wherein said means for projecting comprises a reflective projection means.

5. The visual display system of claim 1 wherein said means for detecting motion comprises a means for detecting change in proximity to said surface relative to said means for projecting.

6. The visual display system of claim 1 wherein said means for detecting motion comprises a means for detecting the angular tilt of said means for projecting.

7. The visual display system of claim 1 wherein said means for detecting motion comprises a means for detecting a change in horizontal and/or lateral position coordinates of said means for projecting.

8. The visual display system of claim 1 wherein said means for compensating comprises a means for digitally altering said image.

9. The visual display system of claim 1 wherein said means for compensating comprises a means for digitally altering a means for transmissive projection.

10. The visual display system of claim 1 wherein said means for compensating comprises a means for digitally altering a means for reflective projection.

11. The visual display system of claim 1 wherein said means for compensating comprises a means for changing the position of a mirror.

12. The visual display system of claim 1 wherein said means for compensating comprises a mechanical process.

13. The visual display system of claim 1 wherein said means for compensating comprises an optical means.

14. The visual information display system of claim 1 wherein said means for projecting is configured to be operated while being held in a user's hand.

15. The visual display system of claim 1 wherein said means for projecting comprises a LCD component.

16. The visual display system of claim 1 wherein said means for projecting comprises a DMD component.

17. The visual display system of claim 1 wherein said means for compensating comprises a means for digitally altering a LCD.

18. The visual display system of claim 1 wherein said means for compensating comprises a means for digitally altering a DMD.

19. An image display system comprising
a means for projecting an image onto a surface,
wherein an image is produced in response to software instructions, and
said display system is adapted so as to be operated while in a users hand.

20. The image display system of 19 wherein a means for transmitting signals to a remote computer is provided.

21. The image display system of 19 wherein a means for receiving signals from a remote computer is provided.

22. An image display system comprising
a means for projecting an image onto a surface,
wherein an image is produced in response to software instructions, and
said display system is adapted so as to be operated while worn by a user.

23. The image display system of 22 wherein a means for transmitting signals to a remote computer is provided.

24. The image display system of 22 wherein a means for receiving signals from a remote computer is provided.
